(19) United States
(12) Patent Application Publication
(10) Pub. No.: US 2002/0097465 A1
(43) Pub. Date: Jul. 25, 2002

(54) Optical network, subscriber side optical transmission apparatus, and office side optical transmission apparatus

(76) Inventor: Kosuke Nobuyasu, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/968,449

(22) Filed: Oct. 1, 2001

(30) Foreign Application Priority Data
Jan. 22, 2001 (JP) 2001-013673

(51) Int. Cl. H04J 14/02; H04B 10/00

(52) U.S. Cl. 359/125; 359/167

(57) ABSTRACT

An optical network which can exhibit a protection function at the time of an abnormality in communication and which is effective in an optical network (PON) comprised of a mix of single configuration equipment and duplex configuration equipment, provided with transmission path switching units, individually assigning different transmission paths defined in a logical layer higher than a physical layer forming the optical transmission system to a working side and standby side of the multiplex configuration equipment, and having a subscriber side transmission path converting unit for converting paths to unique transmission paths assigned to the downstream side and an office side transmission path converting unit for converting paths to unique transmission paths assigned to the upstream side.

### BACKGROUND OF THE INVENTION

1. Field of the Invention

The present invention relates to an optical network provided with a protection function using a duplex mechanism, for example, a passive optical network (PON).

In recent years, optical networks have begun to spread rapidly in order to deal with the skyrocketing increase in the volume of information transferred among subscribers. Typical examples of such optical networks at the present time are the PONs—which use wavelength division multiplex (WDM) technology, directly split an optical signal by a splitter, and send and receive an upstream optical signal and downstream optical signal over a single optical fiber.

The present invention relates to a hardware configuration for realizing a protection function in such an optical network.

2. Description of the Related Art

As will be explained later in further detail with reference to FIG. 22, there were the following problems A) to L) in the related art:

A) Due to restrictions on the lower limit of light intensity when sending and receiving optical signals (Telecommunication Standardization Sector of International Telecommunications Union (ITU-T), Recommendation G.983.1: Broadband optical access systems based on Passive Optical Networks (PON)), the connection distance between the subscriber side and office side has to be made much shorter than the normal connection distance.

B) When a failure occurs at the standby side, the failure is only recognized after actually switching to that side. Therefore, a highly reliable protection function cannot be obtained.

C) Even if an optical line termination (OLT) knows that there is a failure in an optical network unit (ONU) (optical network termination (ONT)) of a certain subscriber, it does not know if that ONU (ONT) is a duplex configuration or a single configuration, so it cannot judge whether to issue a working/standby switching command.

D) Issuing switching commands individually to ONUS (ONTS) requires expansion of messages beyond the standard ones.

E) The switching procedure is not defined in the ITU-T G.983.1, so each vendor establishes its own specifications. As a result, compatibility is lost and connectability to equipment of other vendors cannot be secured.

F) The content described in the so-called K1/K2 bytes and the switching procedure differ depending on which mode of ANNEX (A) and ANNEX (B) of ITU-T G.783 the K1/K2 bytes adopt. As a result, connection to equipment of other vendors cannot be guaranteed.

G) Messages for switching the operating sides of the PON line terminals (PON-LT) for the ONU (ONT) #1 to #N cannot be received at the standby sides.

H) Partial switching such as just ONU (ONT) #1 is not possible. Therefore, full switching of the optical distribution network (ODN) (working/standby switching) becomes necessary. The service ends up being totally shut down temporarily.

I) To eliminate the above inconvenience of H), specifications for special operation not defined in the ITU-T G.983.1 become necessary and therefore in the end, connection with equipment of other vendors cannot be guaranteed.

J) It is not possible to mix single configuration ONUs (ONTS) and duplex configuration ONUs (ONTS) in the same ODN.

K) It is difficult to distinguish between failure of a branch line of the ODN (between subscriber side and splitter group) and overall failure of a trunk line (between each splitter and an office side).

L) When switching between the working and standby sides, as much as 195 seconds are required for the switching time. This however substantially means a total shutdown of the service and therefore is not practical.

### SUMMARY OF THE INVENTION

An object of the present invention is to provide an optical network which can solve the above problems, that is, which can reliably exhibit a protection function at the time of an abnormality in communication even with a system configuration comprised of a mixture of single configuration equipment and duplex configuration equipment.

Another object of the present invention is to provide a subscriber side optical transmission apparatus for use in such an optical network.

Still another object of the present invention is to provide an office side optical transmission apparatus for use in such an optical network.

To attain the above first object, according to the present invention, there is provided an optical network (1) comprised of a mix of single configuration equipment and multiplex configuration equipment (11(0), 11(1)) provided with a transmission path switching means (12, 22), individually assigning different transmission paths defined in a logical layer higher than a physical layer forming the optical transmission system (2) to a working side and standby side of the multiplex configuration equipment, and having a subscriber side transmission path converting means (13) for converting paths to unique transmission paths assigned to the downstream side and an office side transmission path converting means (23) for converting paths to unique transmission paths assigned to the upstream side. Due to this, an effective protection system against communication abnormalities is realized in an optical network (PON) comprised of a mix of single configuration equipment and duplex configuration equipment.

### BRIEF DESCRIPTION OF THE DRAWINGS

The above object and features of the present invention will be more apparent from the following description of the preferred embodiments given with reference to the accompanying drawings, wherein:

FIG. 1 is a view of the basic configuration of an optical network according to the present invention;

FIG. 2 is a view of an optical network according to a first embodiment;

FIG. 3 is a view of another optical network according to the first embodiment;

FIG. 4 is a view of a switching sequence of the first embodiment in the case where a failure occurs between an ONU (ONT) and switch/converter (SW/CONV);

FIG. 5 is a view of a switching sequence of the first embodiment in the case where a failure occurs in a branch line between an ONU (ONT) and OLT;

FIG. 6 is a view of a switching sequence of the first embodiment in the case where a failure occurs in a trunk line between an ONU (ONT) and OLT;

FIG. 7 is view of an optical network according to a second embodiment;

FIG. 8 is a view of a switching sequence of the second embodiment in the case where a failure occurs between an ONU (ONT) and SW/CONV;

FIG. 9 is a view of a switching sequence of the second embodiment in the case where a failure occurs in a branch line between an ONU (ONT) and OLT;

FIG. 10 is a view of a switching sequence of the second embodiment in the case where a failure occurs in a trunk line between an ONU (ONT) and OLT;

FIG. 11 is a view of an optical network according to a third embodiment;

FIG. 12 is a view of another optical network according to the third embodiment;

FIG. 13 is a view of a switching sequence of the third embodiment in the case where a failure occurs in a branch line between an ONU (ONT) and OLT;

FIG. 14 is a view of a switching sequence of the third embodiment in the case where a failure occurs in a trunk line between an ONU (ONT) and OLT;

FIG. 15 is a view of a switching sequence of the third embodiment in the case where a failure occurs in a splitter group 3 between an ONU (ONT) and OLT;

FIG. 16 is a view of an optical network according to a fourth embodiment;

FIG. 17 is a view of a switching sequence of the fourth embodiment in the case where a failure occurs in a branch line between an ONU (ONT) and OLT;

FIG. 18 is a view of a switching sequence of the fourth embodiment in the case where a failure occurs in a trunk line between an ONU (ONT) and OLT;

FIG. 19 is a view of a switching sequence of the fourth embodiment in the case where a failure occurs in a splitter group 3 between an ONU (ONT) and OLT;

FIG. 20 is a view of an example of a unitary subscriber side optical transmission apparatus;

FIG. 21 is a view of a specific example of the SW/CONV (32, 42); and

FIG. 22 is a view of an example of the configuration of an optical network of the related art provided with a protection function.

### DESCRIPTION OF THE PREFERRED EMBODIMENTS

Before describing the embodiments of the present invention, the related art and the disadvantages therein will be described with reference to the related figures.

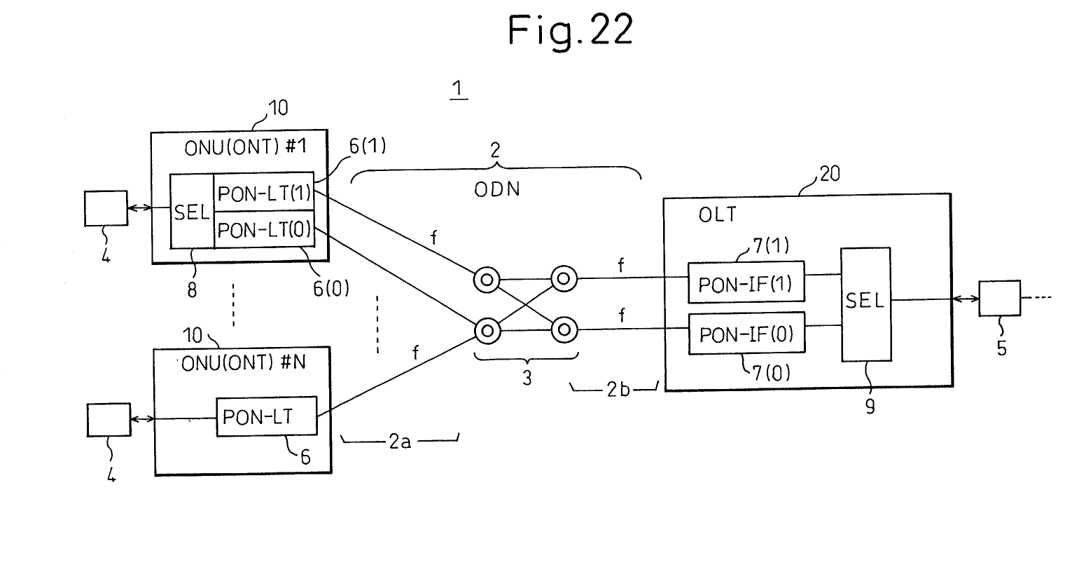

FIG. 22 is a view of an example of the configuration of an optical network of the related art provided with a protection function.

In the figure, the optical network 1 includes a plurality (N number of) subscriber side optical transmission apparatuses 10, an office side optical transmission apparatus 20 for sending and receiving optical signals with these subscriber side optical transmission apparatuses 10, and an optical transmission system 2 for sending and receiving these optical signals, that is, performing optical communication.

The optical transmission system 2 includes a tree-like group of optical fibers 1 and a splitter group 3 inserted in them. The subscribers 4 and office 5 communication through this optical transmission system 2. Note that the office 5 may be considered as an exchange.

An example of the configuration of the optical network of FIG. 22 will be explained in further detail next.

This example of the configuration is one example of a confounding system configuration, that is, the configuration of Figure IV.2/G.983.1-Duplex ATM-PON system d) of ITU-T G.983.1, APPENDIX IV (Access network survivability), IV.3.1: Configuration examples. Here, each subscriber side optical transmission apparatus 10 shown in FIG. 22 is specifically an ONU or ONT, while the office side optical transmission apparatus 20 is specifically an OLT. Note that the ONU and ONT are apparatuses defined in Recommendations G983.1 and G983.2. In the present invention, however, there is no point in treating these two differently, so they are indicated as ONU (ONT).

The protection function in the optical network 1 of FIG. 22 is realized by a duplex mechanism. This duplex mechanism is shown as the duplex configuration PON-LT6(0) and 6(1) in the ONU (ONT) #1 or as the duplex configuration PON-IF7(0) and 7(1) in the OLT. On the other hand, the PON-LT6 in ONU(ONT) #N is a single configuration PON-LT. These duplex configurations (6(0), 6(1) and 7(0), 7(1)) form a so-called working side (0) and standby side (1) in the optical network 1. When some sort of failure occurs, the above protection function is exhibited by switching between the working side (0) and standby side (1). This switching is performed by a selector (SEL) 8 at the subscriber 4 side and by a selector (SEL) 9 at the office 5 side.

Further, in FIG. 22, the optical transmission system 2 is specifically an ODN.

Further, referring to FIG. 22, the PON-LTs 6, 6(0), and 6(1) of all of the ONUs or ONTs 10 are connected to duplex configuration PON interfaces (PON-IF) 7(0) and 7(1) in the OLT 20 at a upstream end of the ODN 2 through a four-unit two-stage configuration splitter group 3. The OLT is a duplex configuration, but the ONUs (ONTs) may be either duplex configurations or single configurations. In this case, the standby sides (1) of the OLTs and ONUs (ONTs) become cold standbys. That is, the standby sides are powered on, but do not emit optical signals. This is because if these output optical signals, they would interfere with the working side optical signals at the splitter group 3.

In general, as explained above, the ONUs (ONTS) may each be duplex configurations or single configurations. Which configuration to adopt is left to the carrier or the subscriber. As a result, at the subscriber side, there ends up to be a mix of single configuration PON-LTs and duplex configuration PON-LTs (0) and PON-LTs (1). Such a mix however causes inconveniences in the above protection function. The present invention focuses on solving these inconveniences caused by this mix. These will be explained in detail as topics A) to L) summarized above.

The topics A) to L) are, in detail, as follows:

A) Assume that there are 32 ONUs (ONTs), that is, ONU (ONT) #1 to #32, in FIG. 22 and that all of the ONUs (ONTS) are duplex configurations. In this case, the intensity of light at the connectors with the ODN 2 becomes equivalent to the light intensity in the case of connecting 64 ONUS (ONTS) using a 64-branch optical star coupler (splitter group 3) and therefore the light intensity drops by a large margin. This being the case, due to restrictions on the lower limit of light intensity when sending and receiving optical signals (ITU-T G.983.1), the connection distance between the subscriber 4 side and office 5 side has to be made much shorter than the normal connection distance (maximum of 32 ONUs/ONTs and no duplex configuration).

B) The standby side 7(1) of the duplex configuration PON-LT in the OLT 20 has to be a cold standby (explained above). This being the case, when it becomes necessary to switch the standby side to the working side, it is not possible to check the standby side for normality before switching. Therefore, if a failure has occurred at the standby side, the failure is only recognized after actually switching to that side. Therefore, a highly reliable protection function cannot be obtained.

C) Whether an ONU (ONT) is a duplex configuration or a single configuration cannot be autonomously checked under the current recommendations (ITU-T G.983.1). That is, even if the OLT 20 knows that there is a failure in an ONU (ONT) of a certain subscriber, it does not know if that ONU (ONT) is a duplex configuration or a single configuration, so it cannot judge whether to issue a working/standby switching command.

Note that a provision relating to this issue may be added in ITU-T G.983.2: The ONT Management and Control Interface Specifications, but there is no such provision in the current ITU-T G.983.2. Further, the method of control for fiber to the cabinet/curb (FTTC) is not established either.

D) When trying to use the K1/K2 bytes used in the known automatic protection switching (APS) system for protection, the K1/K2 bytes are carried by the PON section trace (PST) message. The PST message sent in the downstream direction, however, is only broadcast in the framework of the PON. No means for individually instructing switching to ONUs (ONTS) is established in the ITU-T G.983.1. Therefore, issuing switching commands individually to ONUs (ONTS) requires expansion of messages beyond the standard ones.

E) As explained above, the switching procedure is not defined in the ITU-T G.983.1, so each vendor establishes its own specifications when the switching is to be performed. As a result, compatibility is lost and connectability to equipment of other vendors cannot be secured.

F) It is not clearly indicated as to which mode of ANNEX (A) and ANNEX (B) of ITU-T G.783: Characteristics of synchronous digital hierarchy (SDH) equipment functional blocks the K1/K2 bytes alluded to in ITU-T G.983.1 designate. Therefore, the content described in the K1/K2 bytes and the switching procedure differ depending on which mode of ANNEX (A) and ANNEX (B) is adopted. As a result, connection to equipment of other vendors cannot be guaranteed.

In regard to this, for example, there are the concepts of a working side/standby side in ITU-T G.783 ANNEX (B), but not in ITU-T G.783 ANNEX (A). Therefore, a name alteration procedure for the working side/standby side is necessary in ITU-T G.783 ANNEX (B), but not necessary in ITU-T G.783 ANNEX (A). Further, no standard scheme for the a confounding type (or cold standby) switching procedure has yet been realized.

G) Looking at the duplex configuration PON-LTs 6(0) and 6(1) on the ONU (ONT) side, to realize switching between the PON-LTs 6(0) and 6(1), it is necessary that the ONU (ONT) #1 to #N receive individual messages even though the standby sides are in the cold standby state. Even if trying to receive them, the standby sides are still in the cold standby state, so have not yet started up. Therefore, they cannot receive the PON identification (PON-IDs) required for receiving individual messages. That is, they cannot receive any messages other than broadcast messages. Therefore, messages for switching the operating sides of the PON-LTS for the ONU (ONT) #1 to #N cannot be received at the standby sides.

H) Assume that the working side PON-LT 7(0) of the OLT 20 fails. In this case, the PON-ID will be lost at the working side as well. Therefore, it becomes impossible to detect the APS bytes for each of the ONU (ONT) #1 to #N. That is, partial switching such as just ONU (ONT) #1 is not possible. Therefore, full switching of the ODN (working/standby switching) becomes necessary. The service ends up being totally shut down temporarily.

I) To eliminate the above inconvenience of H), it is necessary that the standby PON-LT of the OLT also recognize the acquired PON-ID when the working side PONLT of the OLT 20 is in operation and that the PST message be received by both the working and standby sides. Such operating specifications however are outside the provisions of the ITU-T G.983.1. Therefore in the end, connection with equipment of other vendors cannot be guaranteed.

J) When sending switching instructions to the ONU (ONT) #1 to #N by a broadcast from the OLT, it is not possible to individually designate the equipment receiving the instructions (ONU (ONT) #1 to #N), so all of the ONU (ONT) #1 to #N are switched at one time. Single configuration ONUs (ONTS) (for example, #N), however, cannot switch, so it is not possible to mix single configuration ONUs (ONTs) and duplex configuration ONUs (ONTs) in the same ODN.

K) It is difficult to distinguish between failure of a branch line 2a of the ODN (between subscriber 4 side and splitter group 3) and overall failure of a trunk line 2b (between each splitter and an office 5 side).

L) When switching between the working and standby sides, the switching time becomes the alarm protection time of 1 second+PST message transmission time of 1 second+ONU (ONT) startup time of 3 seconds×(total number of PON-LTs in all connected ONUs (ONTs) (maximum 64))+PST message receiving time of 1 second, or as much as 195 seconds (in the case of 32 duplex configuration ONUs/ONTs). This however substantially means a total shutdown of the service and therefore is not practical.

Therefore, the present invention provides an optical network which can solve the above problems, that is, which can reliably exhibit a protection function at the time of an abnormality in communication even with a system configuration comprised of a mixture of single configuration equipment and duplex configuration equipment. The present invention will be explained in detail below.

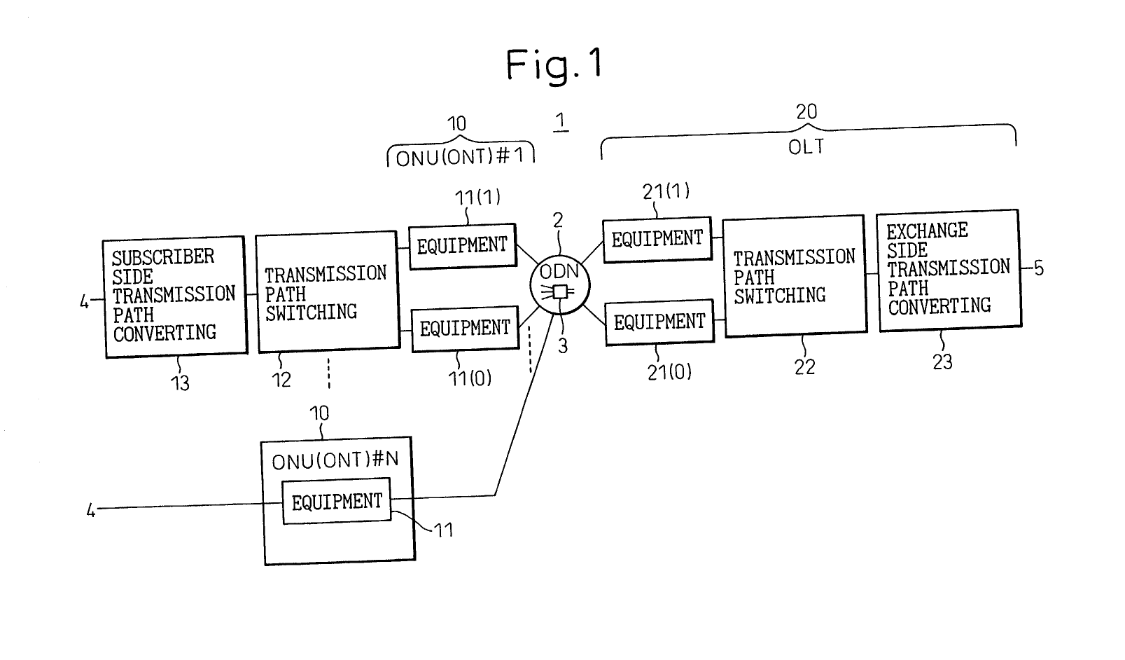

FIG. 1 is a view of the basic configuration of an optical network according to the present invention.

First, the optical network 1 upon which the present invention is predicated is an optical network comprised of subscriber side optical transmission apparatuses 10, an optical transmission system 2 connected to the subscriber side optical transmission apparatuses 10, and an office side transmission apparatus 20 for optical communication with the subscriber side optical transmission apparatuses 10 through the optical transmission system 2, wherein at least one of the subscriber side optical transmission apparatuses 10 and office side optical transmission apparatus 20 is comprised of a mix of single configuration equipment 11 and multiplex configuration equipment 11(0), 11(1), 21(0), and 21(1).

Here, the “single configuration equipment 11” and the “multiplex configuration equipment 11(0) and 11(1)” correspond to the PON-LT 6 and the PON-LT 6(0) and 6(1) in FIG. 22 explained above. Further, here, use is made of the expression “multiplex configuration equipment” rather than “duplex configuration equipment” because the present invention is not limited to a duplex configuration. It is possible to easily expand the protection function to triplex configuration or quadraplex configuration equipment as well if necessary. The detailed explanation to follow, however, will be made with reference to a duplex configuration as a typical example.

The basic characterizing features of the present invention in the optical network 1 upon which the present invention is predicated lie in the following points:

Provision of transmission path switching means 12 and 22 at least one of the subscriber side transmission apparatuses 10 and office side transmission apparatus 20 and

individual assignment of different transmission paths defined at a logical layer higher than the physical layer forming the optical transmission system 2 to each of the working sides and standby sides of the above multiplex (duplex) configuration equipment and the above single configuration equipment by the transmission path switching means 12 and 22.

More preferably, a subscriber side transmission path converting means 13 for converting the above transmission paths assigned on the optical transmission system 2 to unique transmission paths assigned to the downstream side (subscriber 4 side) from the subscriber side optical transmission apparatus 10 is added to the transmission path switching means 12.

Similarly, an office side transmission path converting means 23 for converting the above transmission paths assigned on the optical transmission system 2 to unique transmission paths assigned to the upstream side (office 5 side) from the office side optical transmission apparatus 20 is added to the transmission path switching means 22.

Here, a more detailed explanation will be given of the “different transmission paths defined at a logical layer higher than the physical layer forming the optical transmission system 2”.

When the optical network 1 is an asynchronous transfer mode (ATM) network, the above different transmission paths can be formed by different specific virtual paths (VPs) or specific virtual channels (VCs).

Further, when the optical network 1 is a synchronous transfer mode (STM) network, the above different transmission paths can be formed by different specific time slots.

In the detailed explanation given later, however, reference is made to virtual paths (VPs) based on the ATM network as transmission paths. When based on the STM network, it is sufficient to consider the same explanation except for replacing the VPs with time slots.

Note that the above transmission path switching means 12 and 22 execute switching operations when a communication abnormality occurs on the optical transmission system 2. In this case, the communication abnormality may be detected based on the results of monitoring of the performance of the VPs or by detection of line errors.

Next, as embodiments, four modes of optical networks (PON) based on the present invention will be explained. Further, examples of the PON protection operation in these modes will be explained.

(First Embodiment)

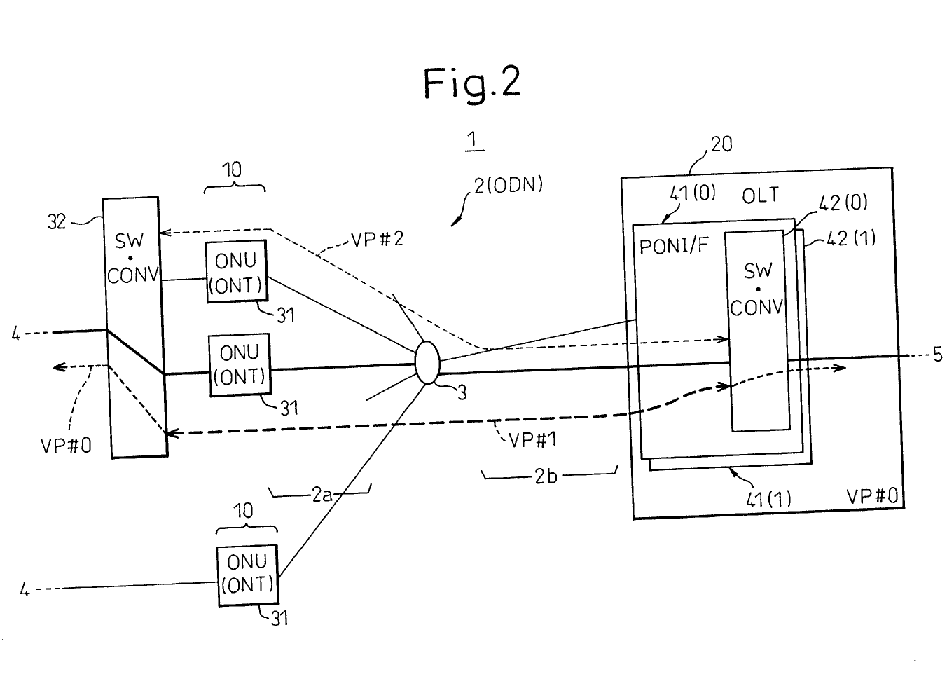

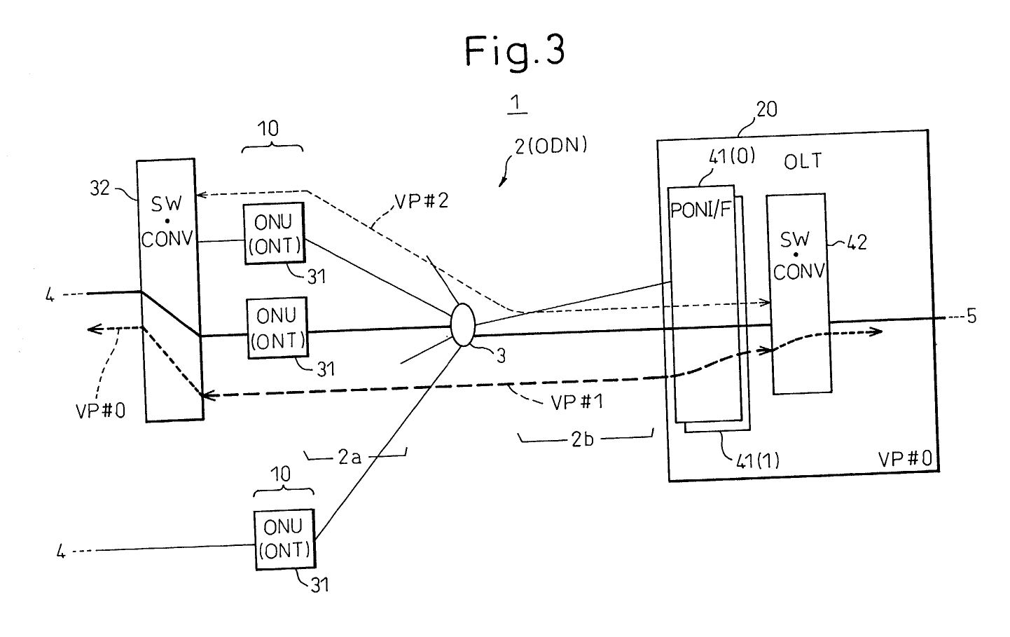

FIG. 2 is a view of an optical network according to a first embodiment, while FIG. 3 is a view of another optical network according to the first embodiment. Note that throughout the figures, similar components are shown assigned the same reference numerals or symbols.

The PON (optical network) 1 is comprised of an ODN (optical transmission system) 2 including a splitter group 3 and ONUs (ONTS) (subscriber side optical transmission apparatuses) 31 and an OLT (office side transmission apparatus) 20 arranged at the two sides of the ODN 2 through branch lines 2a and a trunk line 2b. Further, the ONUS (ONTS) 31 (corresponding to equipment 11, 11(0), and 11(1) in FIG. 1) are provided with a switch/converter (SW/CONV) 32, while the OLT 20 is provided inside it with PON-IFs 41(0) and 41(1) (corresponding to the equipment 21(0) and 21(1) in FIG. 1) and switch/converters (SW/CONV) 42(0) and 42(1).

The switch/converter (SW/CONV) 32 of the subscriber 4 side is a single unit combining the transmission path switching (SW) means 12 and transmission path converting (CONV) means 13 of FIG. 1.

On the other hand, each of the switch/converters (SW/CONV) 42 on the office 5 side is a single unit combining the transmission path switching (SW) means 22 and transmission path converting (CONV) means 23 of FIG. 1 .

Next, referring to FIG. 3, while SW/CONVs 42 were provided separately at the office 5 side on the PON-IFs 41(0) and 41(1) in FIG. 2, in the configuration of FIG. 3, a single common one is provided independent from the PON-IFs 41(0) and 41(1) and shared by them. Therefore, in the case of FIG. 3, the configurations of the PON-IFs 41(0) and 41(1) can be simplified from the case of FIG. 2.

The PON 1 based on the first embodiment shown in FIG. 2 and FIG. 3 is an “OLT only duplex system with dual path connection” (20NU (ONT)/1 splitter) type PON. That is, it is a PON where only the OLT 20 is duplexed and two path connections (two paths set by branch line 2a) are formed. This will be explained in further detail below.

Two single configuration ONUs (ONT) 31 are installed at the subscriber's home and paths are set up for each by different virtual paths VPs (or time slots). Further, a SW/CONV 32 having a VP (or time slot) switching function is installed at the user interface side of the ONUs (ONTS) 31, while VP (or time slot) switch (SW) and conversion (CONV) functions are given on the PON-IF 41 in the OLT 20 or upstream from it as a SW/CONV 42.

When a failure occurs in such an environment, the subscriber 4 side or the OLT 20 side switch the VP (or time slot) and convert the VP (or time slot). Due to this, the path is switched and the ODN 2 is protected. Note that it is possible to obtain two systems (two systems of FIG. 2 and FIG. 3) depending on the position of mounting of the VP (or time slot) switching and conversion unit, that is, the SW/CONV 42, on the OLT 20.

According to the above system of the present invention,

(i) the number of optical branchings becomes smaller than the related art, or a maximum 32 or the same number as the connected ONUs (ONTS) 31, and the above problem A) can be eliminated.

(ii) an ONU (ONT) 31 requires only one PON-LT 6 and the ONU (ONT) 31 need not be provided with any additional functions. Therefore, realization of a switching function does not rely on the structure or functions of the ONU (ONT) 31 and, accordingly, the ONU (ONT) 31 need not be aware of a state of a duplex configuration. Further, the VP (or time slot) switching does not have any effect on the PON-Layer, so a general device can be used as the SW/CONV 32 for the VP (or time slot) switching on the ONU (ONT) 31 side. As a result, connection with equipment of other vendors becomes possible. That is, the above problems C), D), E), F), and J) can be solved.

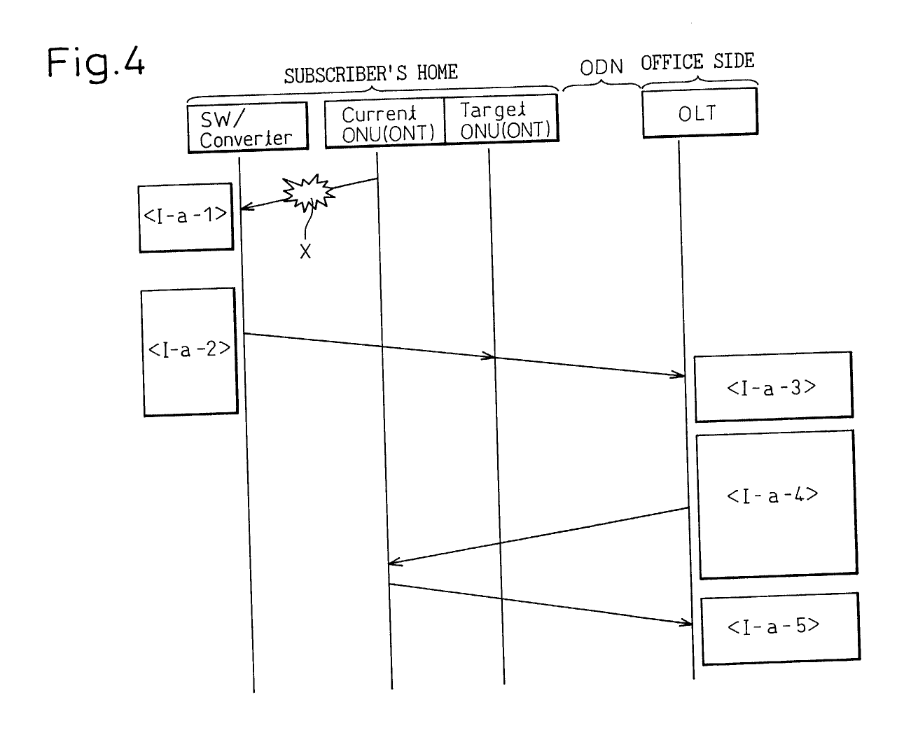

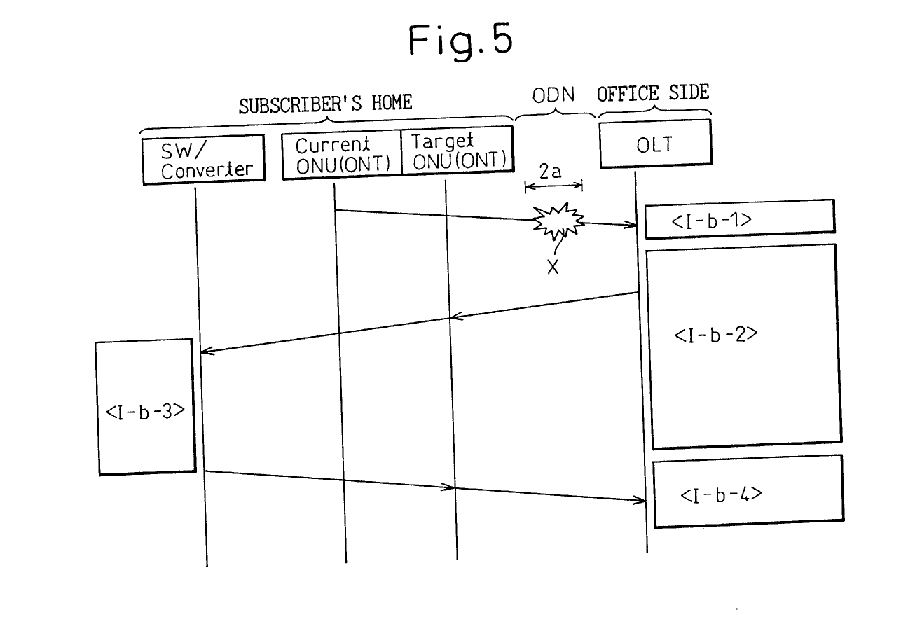

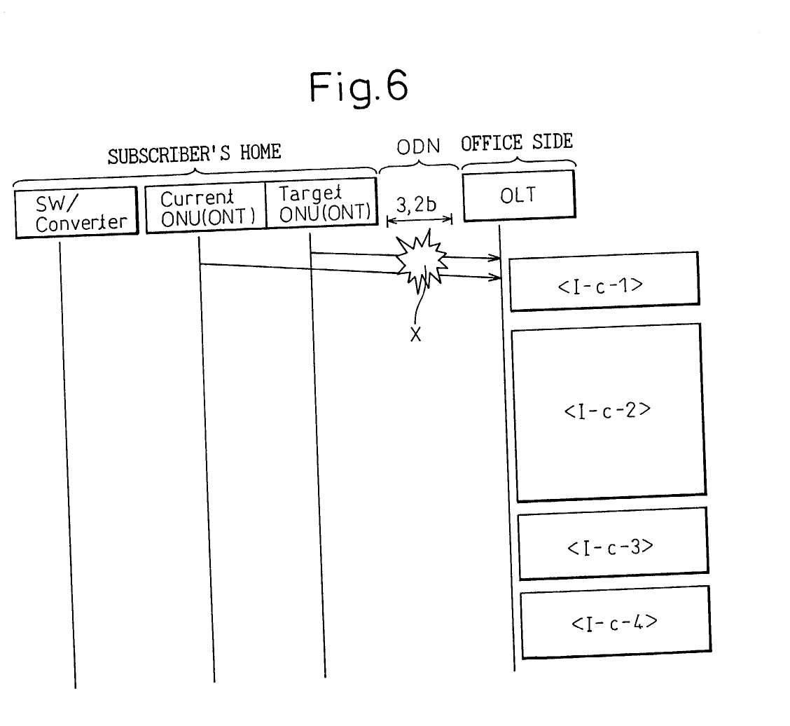

Further, a failure on a branch line and a failure on a trunk line can be differentiated by the analysis sequence shown in the later explained FIG. 4, FIG. 5, and FIG. 6. That is, the above problem K) can be solved.

Further, since the switching of an ONU (ONT) of a subscriber adopting a duplex configuration can be realized by just blocking the failed ONU (ONT) 31, the problem J) can be solved by this means as well.

Still further, since a startup operation is unnecessary, the above problem L) can also be solved.

When applying VP switching (or time slot switching) to a PON system as in the present invention, it is necessary to solve the above problems, particularly C) to K), after considering the characteristics inherent to the PON system. Since the problems C), D), E), F), and J) are already solved as explained above, the problems C) to K) can be solved.

As the SW/CONV 32 installed at the subscriber side, it is possible to use an existing ATM switch or other device. Remote control is easily possible to assigning paths on the ODN 2 for SW/CONV control.

FIG. 4 is a view of a switching sequence of the first embodiment in the case where a failure occurs between an ONU (ONT) and SW/CONV;

FIG. 5 is a view of a switching sequence of the first embodiment in the case where a failure occurs in a branch line between an ONU (ONT) and OLT; and

FIG. 6 is a view of a switching sequence of the first embodiment in the case where a failure occurs in a trunk line between an ONU (ONT) and OLT.

First, referring to FIG. 4, assume that a failure X occurs between an ONU (ONT) 31 and SW/CONV 32 in FIG. 2 (or FIG. 3) (failure type a). If this happens, the following operations successively occur in the PON network 1. Note that in the figures after this, the “SW/Converter” indicates the above-mentioned SW/CONV 32, the “Current ONU (ONT)” indicates the currently used ONU (ONT) 31, and the “Target ONU (ONT)” indicates the ONU (ONT) 31 to be switched to due to the occurrence of the failure X. “OLT” is the above-mentioned OLT 20.

<I-a-1> Due to the failure X, the SW/CONV 32 detects a communication abnormality with the current ONU (ONT).

<I-a-2> The SW/CONV 32 blocks communication with the current ONU (ONT). Further, it switches the path VP #2 to the hot standby target ONU (ONT).

<I-a-3> The OLT 20 receives a notification of switching from the SW/CONV 32.

<I-a-4> The OLT 20 judges that there is no abnormality in the ODN 20 and that the abnormality is between the ONU (ONT) and SW/CONV since there is no abnormality in communication with the current ONU (ONT) in view of the location of the failure X. Further, the OLT 20 sends a blocking command to the current ONU (ONT) which can no longer be used.

<I-a-5> The OLT 20 receives a notification of completion of blocking of communication from the current ONU (ONT).

Next, referring to FIG. 5, assume that a failure X occurs in a branch line 2a between an ONU (ONT) 31 and the OLT 20 in FIG. 2 (or FIG. 3) (failure state b). If this happens, the following operations successively occur in the PON network 1.

<I-b-1> Due to the failure X, the OLT 20 detects a communication abnormality with the current ONU (ONT).

<I-b-2> Since the failure is in the branch line 2a and there is no abnormality in communication with the other ONUs (ONTs), the OLT 20 judges that there is an abnormality only in the communication with the current ONU (ONT) and that there is no abnormality in the ODN trunk line 2b and the abnormality is in the branch line 2a with the current ONU (ONT) of the ODN or with the current ONU (ONT). Further, it sends a command for path switching (VP#1-VP#2) to the SW/Converter.

<I-b-3> The SW/CONV 32 blocks communication with the current ONU (ONT). Further, it switches the path to the target ONU (ONT).

<I-b-4> The OLT 20 receives a notification of completion of path switching from the SW/CONV 32.

Next, referring to FIG. 6, assume that a failure X occurs in the trunk line 2b or splitter group 3 between an ONU (ONT) 31 and the OLT 20 in FIG. 2 (or FIG. 3) (failure state c). If this happens, the following operations successively occur in the PON network 1.

<I-c-1> Due to the failure X, the OLT 20 detects a communication abnormality with all ONUs (ONTs).

<I-c-2> Since there is a communication abnormality with all ONUs (ONTs), the OLT 20 judges that the abnormality is not that of a specific ONU (ONT) and that the abnormality is of the trunk line 2b or splitter group 3 of the ODN 2. Further, the OLT 20 blocks its working PON-IF 41(0) and switches to the standby side PON-IF 41(1).

<I-c-3> When the state of communications fails to be restored by <I-c-2>, the OLT 20 detects that communication continues to be impossible with all ONUs (ONTs) even after the completion of switching to the standby side PON-IF 41(1).

<I-c-4> The OLT 20 judges that the abnormality is in the splitter group 3 of the ODN 2. Further, it suspends service of that PON-IF.

(Second Embodiment)

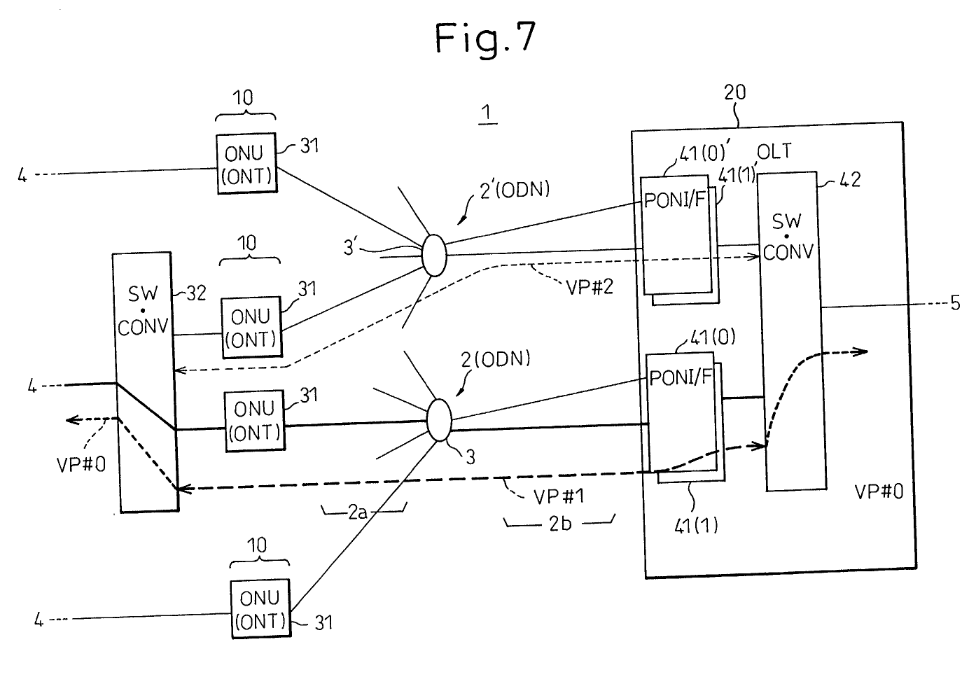

FIG. 7 is view of an optical network according to a second embodiment.

Comparing this figure and FIG. 2 and FIG. 3 (first embodiment), it differs in that an ODN 2′ similar to the ODN 2 shown in FIG. 2 and FIG. 3 is provided independently from the ODN 2. Therefore, for the splitter groups as well, there are simultaneously a splitter group 3 shown in FIG. 2 and FIG. 3 and a similar splitter group 3′. Therefore, in the OLT 20, there are PON-IFs 41(0)′ and 41(1)′ for the ODN 2′ in addition to the PON-IFs 41(0) and 41(1) for the ODN 20. There is however only one SW/CONV 42 in the OLT 20. This is shared by the PON-IFs 41(0), 41(1), 41(0)′, and 41(1)′.

Note that provision of two systems of the ODN such as the ODNs 2 and 2′ is itself known art. This is one technique for enhancing the reliability of communications.

The PON 1 based on the second embodiment shown in FIG. 7 is an “OLT only duplex system with dual path connection” (20NU (ONT)/2 splitters) type PON. As explained above, the second embodiment is configured the same as in the first embodiment except for the provision of two ODNs and can similarly solve the problems A), C), D), E), F), J), K), and L).

In the second embodiment, since duplex ODNs including the splitter groups 3 and 3′ are laid, it is possible to deal with failures in a splitter group by a hot standby as well. As a result, the above problems B) and G) can also be solved and there is no need for a subscriber having a duplex configuration to know about the working side PON-Layer (PON-ID etc.) at the standby side since the PON-Layer is operating even in the ONU (ONT) of the standby side. As a result, the above problems H) and I) can be avoided. Further, the above problems C), D), E), F), and J) can be solved.

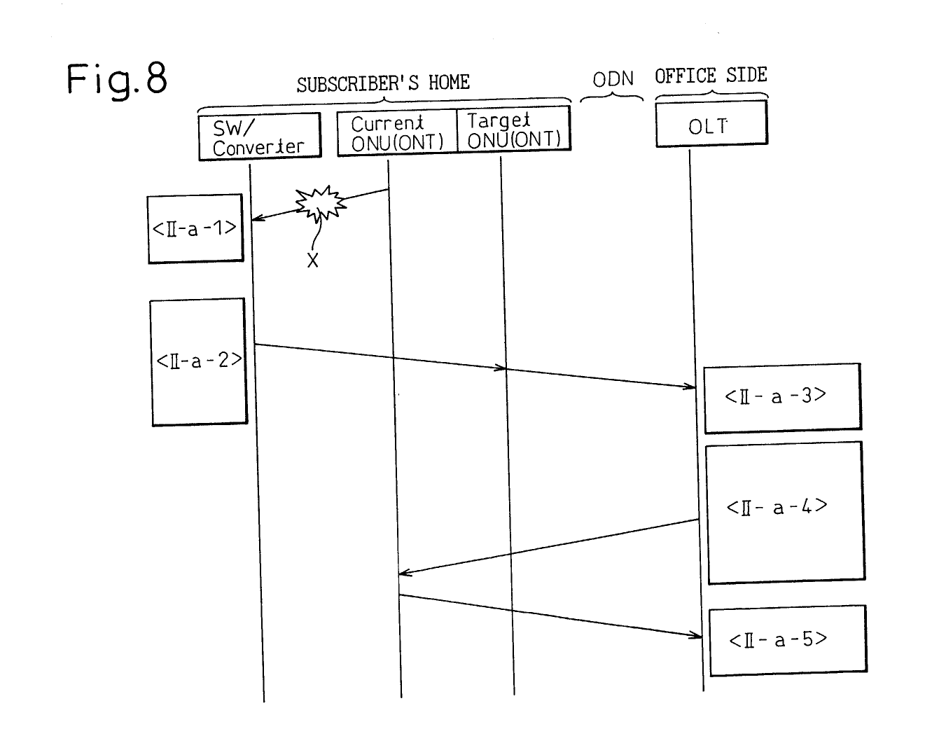

FIG. 8 is a view of a switching sequence of the second embodiment in the case where a failure occurs between an ONU (ONT) and SW/CONV;

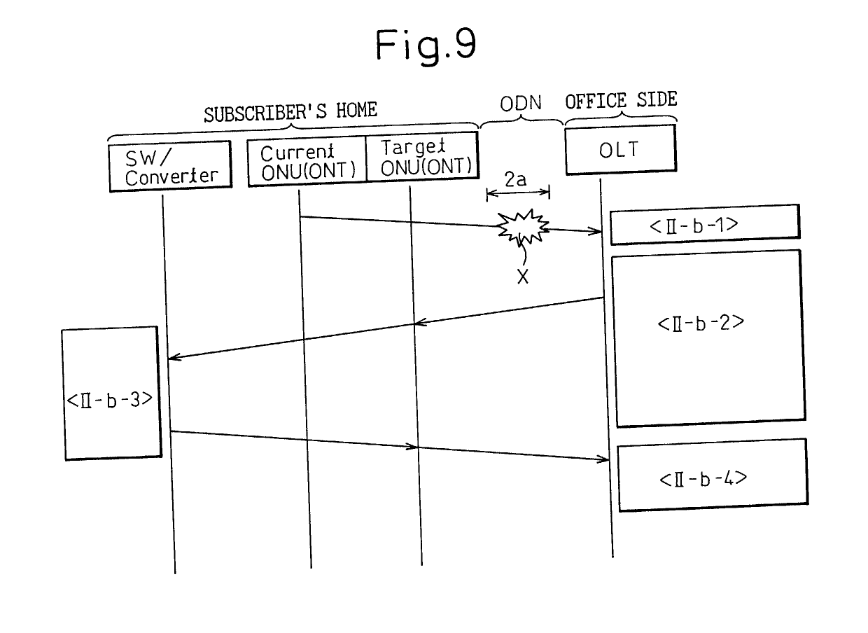

FIG. 9 is a view of a switching sequence of the second embodiment in the case where a failure occurs in a branch line between an ONU (ONT) and OLT; and

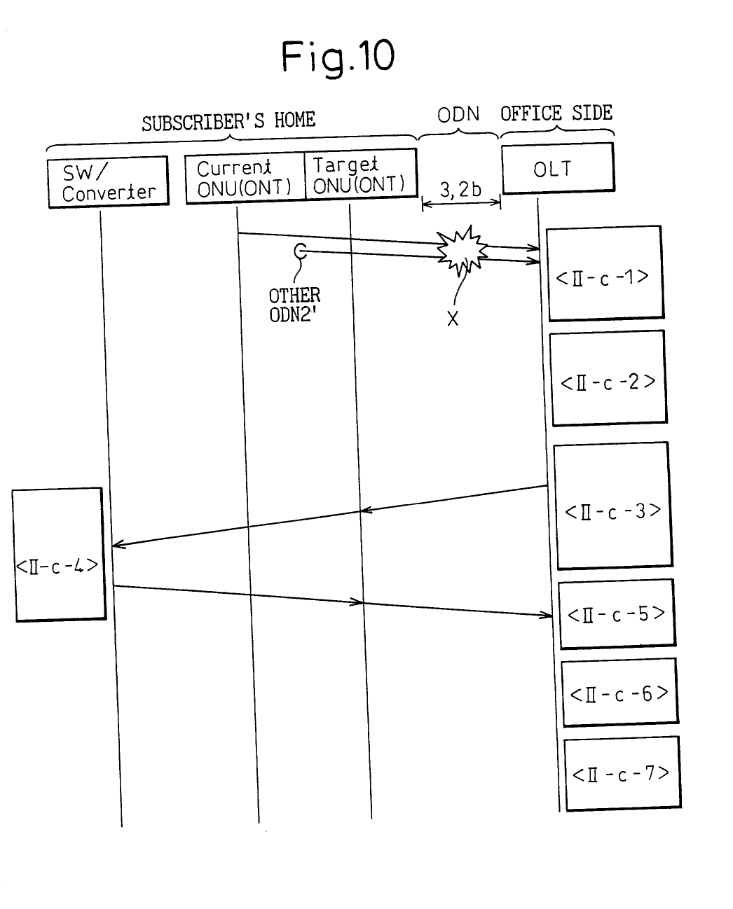

FIG. 10 is a view of a switching sequence of the second embodiment in the case where a failure occurs in a trunk line between an ONU (ONT) and OLT.

First, referring to FIG. 8, assume that a failure X occurs between an ONU (ONT) 31 and SW/CONV 32 in FIG. 7 (failure state a). If this happens, the following operations successively occur in the PON network 1.

<II-a-1> Due to the failure X, the SW/CONV 32 detects a communication abnormality with the current ONU (ONT).

<II-a-2> The SW/CONV 32 blocks communication with the current ONU (ONT). Further, it switches the path to the target ONU (ONT).

<II-a-3> The OLT 20 receives a notification of switching from the SW/CONV 32.

<II-a-4> The OLT 20 judges that there is no abnormality in the ODNs since there is no abnormality in communication with the current ONU (ONT) in view of the location of the failure X. Further, the OLT 20 sends a blocking command to the current ONU (ONT) which can no longer be used.

<II-a-5> The OLT 20 receives a notification of completion of blocking of communication from the current ONU (ONT).

Next, referring to FIG. 9, assume that a failure X occurs in a branch line 2a between an ONU (ONT) 31 and the OLT 20 in FIG. 7 (failure state b). If this happens, the following operations successively occur in the PON network 1.

<II-b-1> Due to the failure X, the OLT 20 detects a communication abnormality with the current ONU (ONT).

<II-b-2> Since there is no abnormality in communication with the other ONUs (ONTs), the OLT 20 judges that there is no abnormality in the trunk line 2b of the ODN 2 and the abnormality is in the branch line 2a of the ODN to the current ONU (ONT) or in the current ONU (ONT). Further, it sends a command for path switching to the SW/Converter.

<II-b-3> The SW/CONV 32 blocks communication with the current ONU (ONT). Further, it switches the path to the target ONU (ONT).

<1I-b-4> The OLT 20 receives a notification of completion of path switching from the SW/CONV 32.

Next, referring to FIG. 10, assume that a failure X occurs in the trunk line 2b or splitter group 3 between an ONU (ONT) 31 and the OLT 20 in FIG. 7 (failure state c). If this happens, the following operations successively occur in the PON network 1.

<II-c-1> Due to the failure X, the OLT 20 detects a communication abnormality with the current ONU (ONT). Simultaneously with this, it detects a communication abnormality with all ONUs (ONTS) accommodated by the PON-IF 41(0).

<II-c-2> The OLT 20 judges that the abnormality is in the trunk line 2b or splitter group 3 of the ODN 2 to which the current ONU (ONT) is connected.

<II-c-3> The OLT 20 sends a command to switch to the standby side path to the SW/CONV 32 under that ODN. Further, it switches its working PON-IF 41(0) in the OLT of the ODN side where the failure occurred to the standby side PON-IF 41(1).

<1I-c-4> The OLT 20 blocks communication with the current ONU (ONT) and switches the path to the target ONU (ONT).

<II-c-5> The OLT 20 receives a notification of completion of path switching from the SW/CONV 32 through the target ONU (ONT).

<II-c-6> Assume that the OLT 20 finds that communication with all ONUs (ONTS) accommodated by the PON-IF is impossible even after switching to the standby side by the above <II-c-5>.

<II-c-7> If this happens, the OLT 20 judges that the abnormality is in the splitter group 3 of the ODN 2 to which that PON-IF is connected. Further, it suspends service of that PON-IF.

(Third Embodiment)

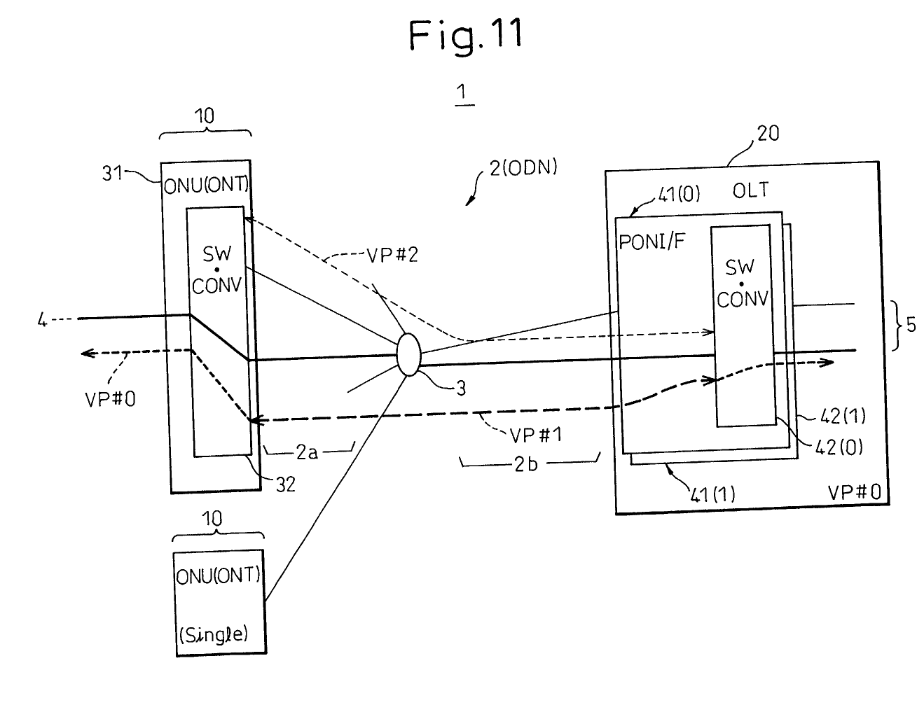

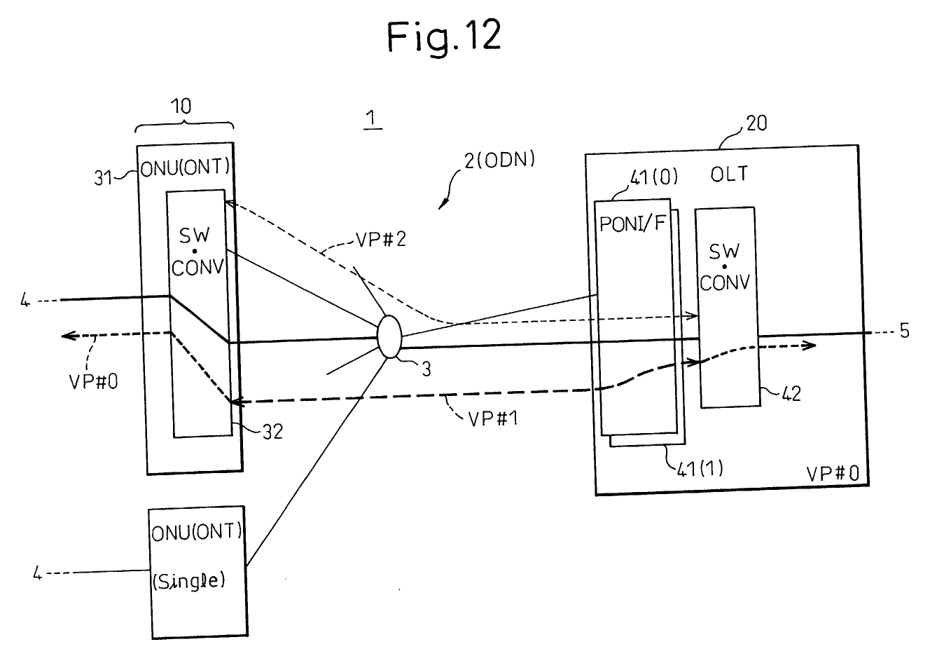

FIG. 11 is a view of an optical network according to a third embodiment; while FIG. 12 is a view of another optical network according to the third embodiment.

In the third embodiment shown in FIG. 11 and FIG. 12, the SW/CONV 32 which had been provided separately from the ONUs (ONTs) 31 in the first and second embodiments is incorporated in each ONU (ONT) 31 and formed integrally with it. This is advantageous to the user in terms of handling and installation space.

Note that the difference between FIG. 11 and FIG. 12 is the same as the difference between FIG. 2 and FIG. 3, that is, the SW/CONV 42 is formed integrally with or separately from the PON-IF 41 in the OLT 20.

The PON 1 based on the third embodiment shown in FIG. 11 and FIG. 12 is an “OLT/ONU (ONT) duplex system with dual path connection” (1 splitter) type PON. That is, it is a PON of a type where both the OLT 20 and the ONUS (ONTS) are duplex configurations and two path connections are formed. This will be explained in further detail.

The third embodiment builds into each ONU (ONT) 31 an SW function having a VP (or time slot) switching and conversion function and two PON-IF (or PON-LT) functions so as to give the subscriber a duplex configuration. The downstream input/output data of the two PON-IF (PON-LT) functions is treated as independent data as input/output data of the VP (or time slot) switching and conversion unit. Therefore, the duplex configuration ONU (ONT) 31 is treated as two independent ONUs (ONTS) 31(0) and 31(1) on the PON-Layer. Accordingly, the designation of a PON-IF at the beginning of startup in the duplex configuration ONU (ONT) (which to first make the working side) can be controlled by deeming and treating the two PON-IFs (LTs) as independent ONUS (ONTs).

Further, since there is no difference in PON-IF (LT) functions in an ONU (ONT) of such a duplex configuration from a single configuration ONU (ONT), it is possible to easily utilize the PON-IF (LT) for a single configuration ONU (ONT) (for example use the PON-IF card as it is).

When the duplex configuration ONU (ONT) of the third embodiment is connected with an OLT of another vendor, the working side/standby side of the duplex configuration ONU (ONT) cannot be switched by a command from the OLT. However, since the I/O functions of the two PON-IFs (LTs) can be treated as two independent ONUs (ONTS) on the PON-Layer, it is clear that it can be connected and used as two single configuration ONUs (ONTS).

Further, while the ONU (ONT) used in the third embodiment does not require any special function from (have any effect on) single configuration ONUs (ONTs), it is possible to connect and use it with single configuration ONUs (ONTs) made by other vendors for subscribers not requiring duplex configuration ONUs (ONTs).

As explained above, the third embodiment is similar to the first embodiment except for adopting its own specifications providing duplex configuration interfaces in ONUs (ONTs) of subscribers with duplex configurations. Note that the duplex configuration interface portions do not require any special functions on the PON-Layer. As a result, the above problems A), C), D), E), F), J), and K) can be solved.

Further, since the duplex configuration ONU (ONT) is treated in the same way as two ONUs (ONTs) on the PON-Layer, when a failure occurs in a branch line (2a) to one of the ONUs (ONTs) of this duplex configuration, it is sufficient to block the PON-IF (LT) connected to the failed branch line. Neither full switching of the ODN of course nor startup of a new ONU (ONT) is required. As a result, the above problem L) can be solved.

Note that it is possible to obtain two systems (two systems of FIG. 11 and FIG. 12) depending on the position of mounting of the VP (or time slot) switching and conversion function (SW/CONV 42) on the OLT 20.

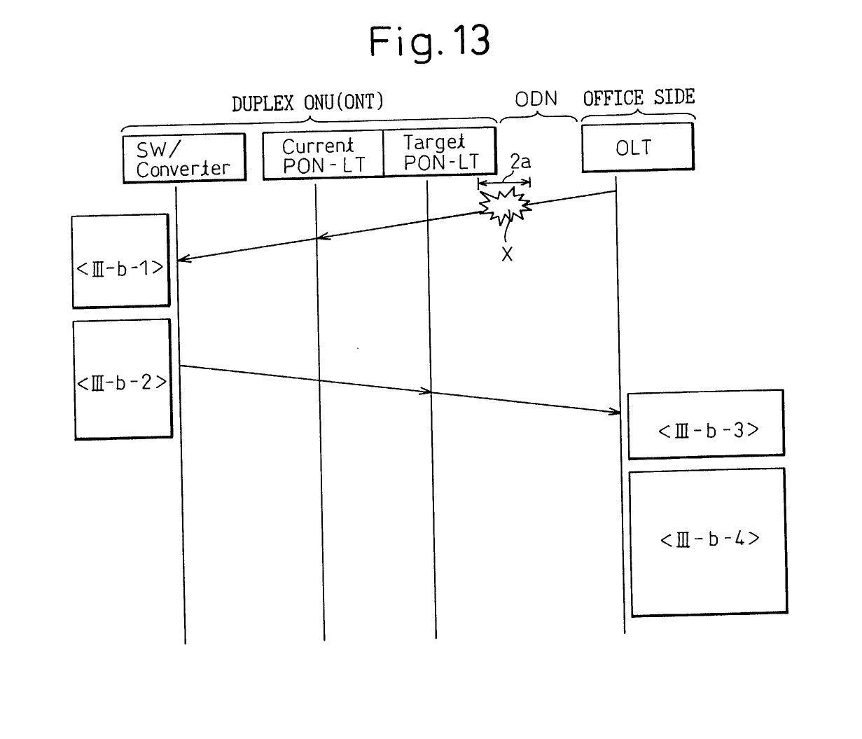

FIG. 13 is a view of a switching sequence of the third embodiment in the case where a failure occurs in a branch line between an ONU (ONT) and OLT;

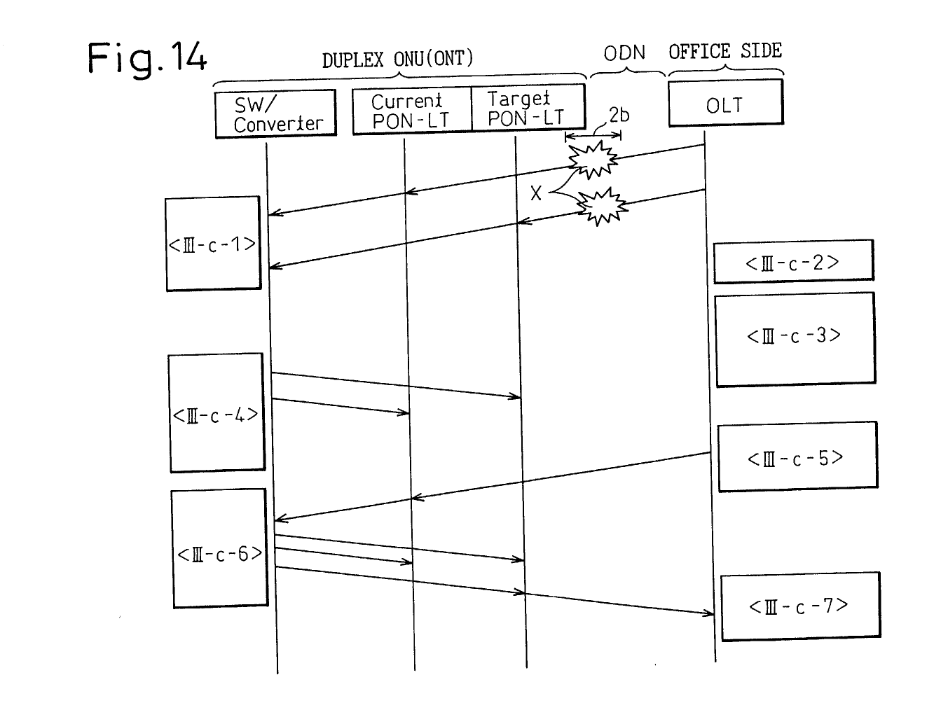

FIG. 14 is a view of a switching sequence of the third embodiment in the case where a failure occurs in a trunk line between an ONU (ONT) and OLT;

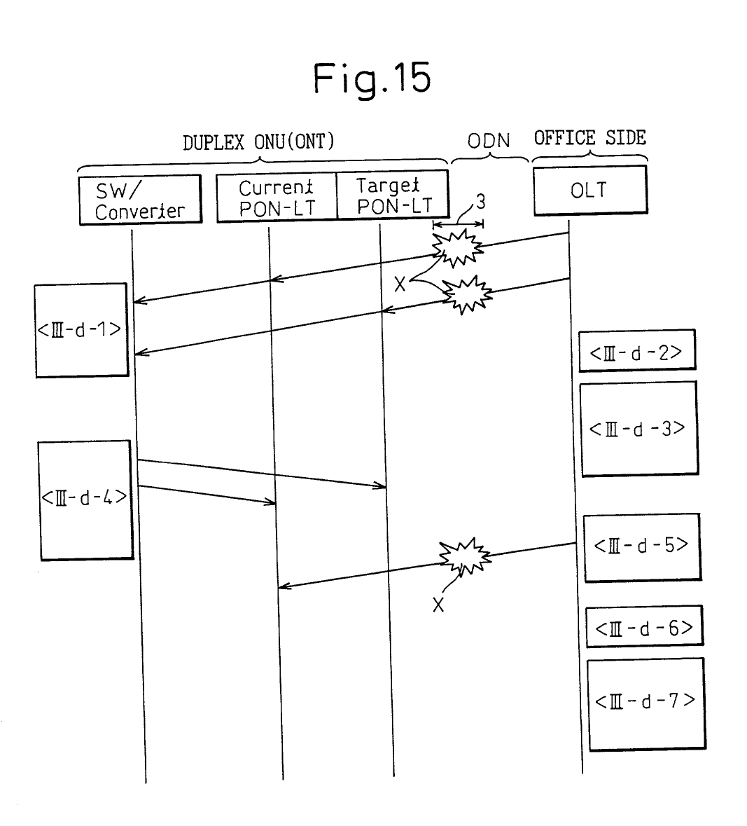

FIG. 15 is a view of a switching sequence of the third embodiment in the case where a failure occurs in a splitter group 3 between an ONU (ONT) and OLT.

First, referring to FIG. 13, assume that a failure X occurs in a branch line 2a between an ONU (ONT) 31 and the OLT 20 in FIG. 11 (or FIG. 12) (failure state b). If this happens, the following operations successively occur in the PON network 1.

<III-b-1> The SW/CONV 32 detects a communication abnormality from the current PON-LT.

<III-b-2> The SW/CONV 32 blocks the current PON-LT. Further, it switches the path to the target PON-LT.

<III-b-3> The OLT 20 receives a notification of path switching from the ONU (ONT).

<III-b-4> Since there is no abnormality in the communication with the other ONUs (ONTs) or the PON-LT (since the failure is in the branch line 2a), the OLT 20 judges that there is no abnormality in the ODN 2 and that the abnormality is between the current PON-LT of the ONU (ONT) and splitter group 3.

Next, referring to FIG. 14, assume that a failure X occurs in the trunk line 2b between an ONU (ONT) 31 and the OLT 20 in FIG. 11 (or FIG. 12) (failure state c). If this happens, the following operations successively occur in the PON network 1.

<III-c-1> The SW/CONV 32 detects a communication abnormality from both (working/standby sides) of the PON-LTs.

<III-c-2> The OLT 20 detects a communication abnormality with all ONUs (ONTs).

<III-c-3> The OLT 20 judges that the abnormality is of the trunk line 2b or splitter group 3 of the ODN 2. Further, the OLT 20 switches the path to the standby side PON-IF.

<III-c-4> The SW/CONV 32 blocks the service of the ONUS (ONTS) and the two PON-LTs by itself.

<III-c-5> The OLT 20 starts up the standby side PON-IF and reconnects the ONUS (ONTs).

<III-c-6> The OLT 20 restarts the service of the ONUS (ONTS) and the operation of the two PON-LTS.

<III-c-7> The OLT 20 receives notifications of restart from the ONUS (ONTs). Here, the OLT 20 judges that the failure was at the trunk line 2b.

Next, referring to FIG. 15, assume that a failure X occurs in the splitter group 3 between an ONU (ONT) 31 and OLT 20 of FIG. 11 (or FIG. 12) (failure state d). If this happens, the following operations successively occur in the PON network 1.

<III-d-1> The SW/CONV 32 detects a communication abnormality from both (working/standby sides) of the PON-LTs.

<III-d-2> The OLT 20 detects a communication abnormality with all ONUs (ONTs).

<III-d-3> The OLT 20 judges that the abnormality is of the trunk line 2b or splitter group 3 of the ODN 2. Further, the OLT 20 switches the path to the standby side PON-IF.

<III-d-4> The SW/CONV 32 blocks the service of the ONUs (ONTS) and the two PON-LTs by itself.

<III-d-5> The OLT 20 starts up the standby side PONIF and reconnects the ONUs (ONTs).

<III-d-6> The OLT 20 finds that communication with all of the ONUs (ONTs) cannot be restarted.

<III-d-7> Here, the OLT 20 judges that the cause of the abnormality was a failure in the splitter group 3 of the ODN 2. Further, it suspends service of that PON-IF.

(Fourth Embodiment)

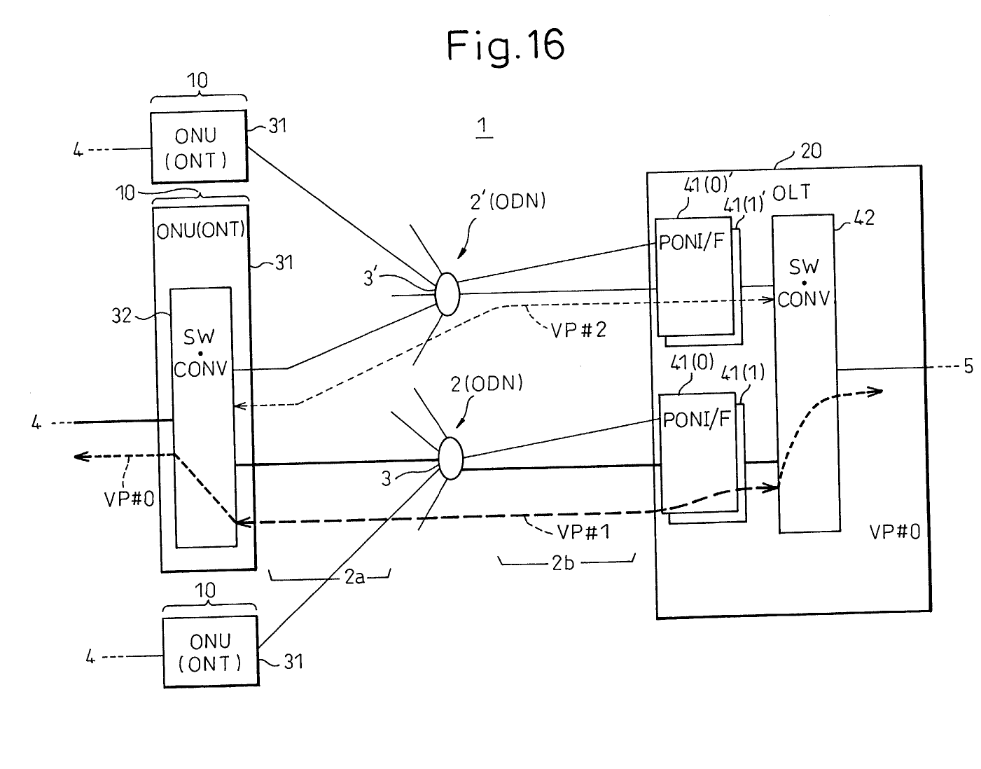

FIG. 16 is a view of an optical network according to a fourth embodiment.

In the same way as the second embodiment being an optical network laying two ODNs (2, 2′) compared with the first embodiment, the fourth embodiment is an optical network laying two ODNs (2, 2′) compared with the third embodiment.

The PON 1 based on the fourth embodiment shown in FIG. 16 is a PON of a “partial duplex system with dual path connection”.

The fourth embodiment lays two ODNs like in the third embodiment so as to enable them to handle failures of the splitter group 3.

In the same way as the third embodiment, the duplex configuration ONUs (ONTs) are unique specifications, so cannot be connected with the OLTs of other vendors, but single configuration ONUs (ONTs) made by other vendors can be used.

The configuration of the fourth embodiment corresponds to a combination of the configurations of the second embodiment and third embodiment. As a result, it is clear that the above problems A), B), C), D), E), F), G), J), K), and L) can be solved and the problems H) and I) can be avoided.

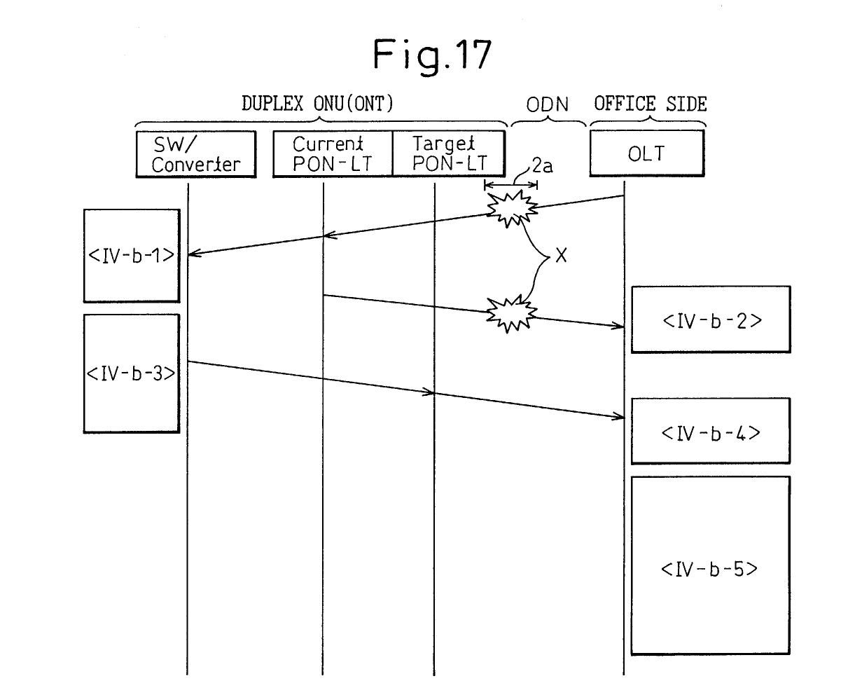

FIG. 17 is a view of a switching sequence of the fourth embodiment in the case where a failure occurs in a branch line between an ONU (ONT) and OLT;

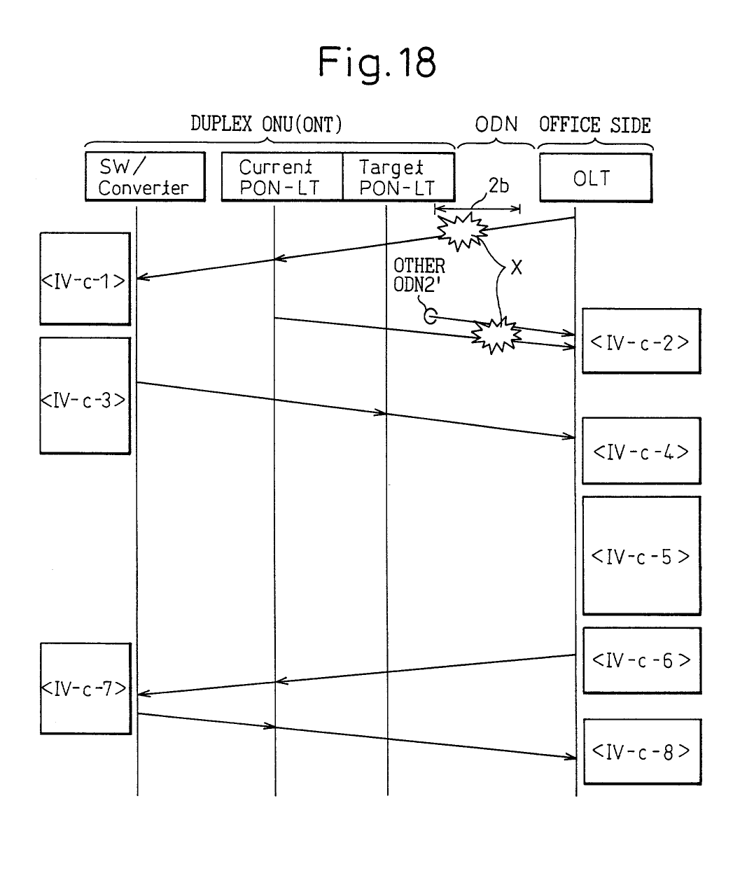

FIG. 18 is a view of a switching sequence of the fourth embodiment in the case where a failure occurs in a trunk line between an ONU (ONT) and OLT; and

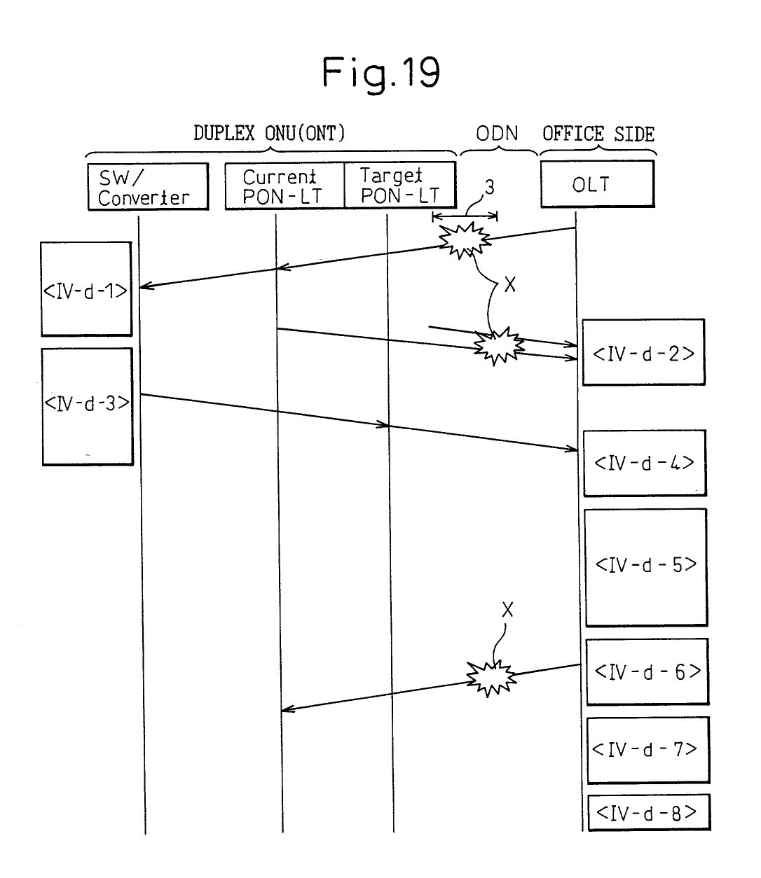

FIG. 19 is a view of a switching sequence of the fourth embodiment in the case where a failure occurs in a splitter group 3 between an ONU (ONT) and OLT.

First, referring to FIG. 17, assume that a failure X occurs in a branch line 2a between an ONU (ONT) 31 and the OLT 20 in FIG. 16 (failure state b). If this happens, the following operations successively occur in the PON network 1.

<IV-b-1> The SW/CONV 32 detects a communication abnormality from the current PON-LT.

<IV-b-2> The OLT 20 detects a communication abnormality with the current PON-LT.

<IV-b-3> The SW/CONV 32 blocks the current PON-LT. Further, it switches the path to the target PON-LT.

<IV-b-4> The OLT 20 receives a notification of path switching from the ONU (ONT).

<IV-b-5> Since there is no abnormality in the communication with the other ONUs (ONTS) or the PON-LT, the OLT 20 judges that there is no abnormality in the current side ODN 2 and that the abnormality is in the current PON-LT of the ONU (ONT) or the branch line 2a of the ODN.

Next, referring to FIG. 18, assume that a failure X occurs in the trunk line 2b between an ONU (ONT) 31 and the OLT 20 in FIG. 16 (failure state c). If this happens, the following operations successively occur in the PON network 1.

<IV-c-1> The SW/CONV 32 detects a communication abnormality from the current PON-LT.

<IV-c-2> The OLT 20 detects a communication abnormality with all ONUs (ONTs) accommodated by the current PON-IF.

<IV-c-3> The SW/CONV 32 blocks the current PON-LT and switches the path to the target PON-LT.

<IV-c-4> The OLT 20 receives notifications of switching from the ONUs (ONTs).

<IV-c-5> Due to receiving the notification, the OLT 20 judges that the abnormality is of the trunk line 2b or splitter group 3 of the ODN to which the current PON-IF is connected. Further, the OLT 20 switches the path to the standby side PON-IF.

<IV-c-6> The OLT 20 starts up the standby side PONIF and reconnects the ONUs (ONTs) accommodated by it.

<IV-c-7> The SW/CONV 32 restarts the PON-LT which was blocked at <IV-c-3> as the standby PON-LT.

<IV-c-8> The OLT 20 receives notifications of completion of restart from the ONUs (ONTs) accommodated. Further, the OLT 20 judges that the failure was at the trunk line 2b.

Next, referring to FIG. 19, assume that a failure X occurs in the splitter group 3 between an ONU (ONT) 31 and OLT 20 of FIG. 16 (failure state d). If this happens, the following operations successively occur in the PON network 1.

<IV-d-1> The SW/CONV 32 detects a communication abnormality from the current PON-LT.

<IV-d-2> The OLT 20 detects a communication abnormality with all ONUs (ONTS) accommodated by the current PON-IF.

<IV-d-3> The SW/CONV 32 blocks the current PON-LT and switches the path to the target PON-LT.

<IV-d-4> On the other hand, the OLT 20 receives notifications of path switching from the ONUs (ONTs).

<IV-d-5> Due to receiving the notification, the OLT 20 judges that the abnormality is of the trunk line 2b or splitter group 3 of the ODN 2 to which the current PON-IF is connected. Further, the OLT 20 switches the path to the standby side PON-IF.

<IV-d-6> The OLT 20 starts up the standby side PONIF and reconnects the ONUs (ONTS) accommodated by it.

<IV-d-7> Assume here the above reconnection with all ONUS (ONTS) accommodated is not possible.

<IV-d-8> If this happens, the OLT 20 judges that the cause of the abnormality was a failure in the splitter group 3 of the ODN 2. It then suspends the service through that PON-IF.

This completes the explanation of the switching sequences executed in the PONs 1 according to the first to fourth embodiments. Next, the configurations of the subscriber side optical transmission apparatuses 10 and the office side optical transmission apparatus 20 will be explained again.

First, looking at a subscriber side optical transmission apparatus 10, the apparatus 10 is one connecting to an optical transmission system (ODN) 2 in an optical network (PON) 1 and including at least multiplex configuration equipment. It is provided with a transmission path switching means 12 and individually assigns different transmission paths defined at a logical layer higher than the physical layer forming the optical transmission system 2 to the working sides and standby sides of the multiplex configurations by the transmission path switching means 12.

Further, a subscriber side transmission path converting means 13 for converting the above transmission paths assigned on the optical transmission system 2 to unique transmission paths assigned to the terminals of the subscribers 4 accommodated is added to the transmission path switching means 12.

In the above configuration, when the optical network 1 is an ATM network, the above different transmission paths can be formed by different virtual paths (VPs) or virtual channels (VCs).

Alternatively, when the optical network 1 is an STM network, the above different transmission paths can be formed by different time slots.

Note that the transmission path switching means 12 switches when a communication abnormality occurs on the optical transmission system 2.

Further, when the above optical transmission system is comprised of a mutually independent first optical transmission system 2 and second optical transmission system 2′, two different transmission paths are assigned to the first and second optical transmission systems 2 and 2′ and the first and second optical transmission systems 2 and 2′ are individually connected to the working sides and standby sides of the multiplex configuration equipment (FIG. 7 and FIG. 16).

Further, a transmission path switching means 12 and subscriber side transmission path converting means 13 may be incorporated in multiplex configuration equipment and formed integrally with the multiplex configuration equipment (FIG. 12 and FIG. 16).

Note that the multiplex configuration equipment is comprised having at least a first optical line termination unit (PON-LT) 6(0) and second optical line termination unit (PON-LT) 6(1) corresponding to the at least two different transmission paths.

Next, looking at the office side optical transmission apparatus 20, the apparatus 20 is an apparatus connected to an optical transmission system (ODN) 2 in an optical network (PON) 1 and having multiplex configuration equipment. It is provided with a transmission path switching means 22 and performs optical communication with the subscriber side by selectively switching different transmission paths defined at a logical layer higher than the physical layer forming the optical transmission system 2 by the transmission path switching means 22.

Further, an office side transmission path converting means 23 for converting the above transmission paths assigned on the optical transmission system 2 to unique transmission paths assigned to the office 5 side is added to the transmission path switching means 22.

In the above configuration, when the optical network 1 is an ATM network, the above different transmission paths can be formed by different virtual paths (VPs) or virtual channels (VCs).

Alternatively, when the optical network 1 is an STM network, the above different transmission paths can be formed by different time slots.

Note that the transmission path switching means 22 switches when a communication abnormality occurs on the optical transmission system 2.

Further, the multiplex configuration equipment is comprised of at least a first optical interface 41(0) and second optical interface 41(1) corresponding to the working side and standby side.

Further, a transmission path switching means 22 and office side transmission path converting means 23 may be integrally incorporated in each of the first optical interface 41(0) and second optical interface 41(1) (41(0) and 41(1) of FIG. 2 and FIG. 11).

Alternatively, a transmission path switching means 22 and office side transmission path converting means 23 may be provided in parallel with the first optical interface 41(0) and second optical interface 41(1) and shared by the first and second optical interfaces (42 in FIG. 3, FIG. 7, FIG. 12, and FIG. 16).

Further, when the optical transmission system is comprised of a mutually independent first optical transmission system 2 and second optical transmission system 2′, the first optical interface 41(0) may be made the optical interface configured multiplexly for the first optical transmission system 2 and the second optical interface 41(1) may be made the optical interface configured multiplexly for the second optical transmission system 2′.

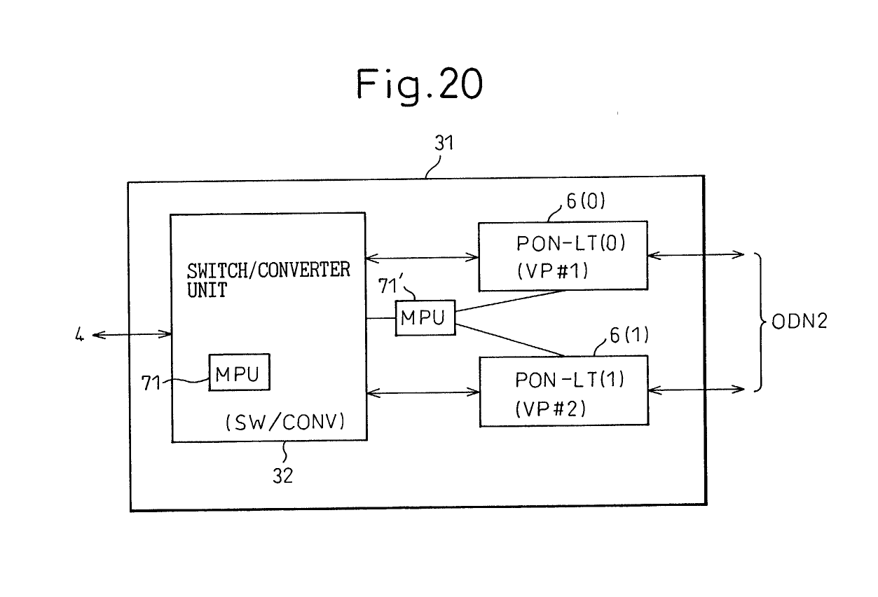

FIG. 20 is a view of an example of a unitary subscriber side optical transmission apparatus.

The apparatus 10 of this figure is the above-mentioned ONU (ONT) 31. The example is shown of assigning a first transmission path VP#1 to the PON-LT (0) and assigning a second transmission path VP#2 to the PON-LT (1).

A processor is of course required for executing the switching sequences explained above (FIG. 4 to FIG. 6, FIG. 8 to FIG. 10, FIG. 13 to FIG. 15, and FIG. 17 to FIG. 19). For example, it may be an MPU. Referring to FIG. 20, this MPU can be provided as the unit 71 inside the SW/CONV 32 (which may be configured by a commercially available ATM-SW) at the subscriber 4 side. Alternatively, it may be provided independently as a unit 71′ outside of the ATM-SW.

The office 5 side may similarly be provided with an MPU (71 or 71′) inside the OLT 20 as shown in FIG. 20.

Finally, an explanation will be made of a concrete example of the transmission path switching means (12, 22) and transmission path converting means (13, 23).

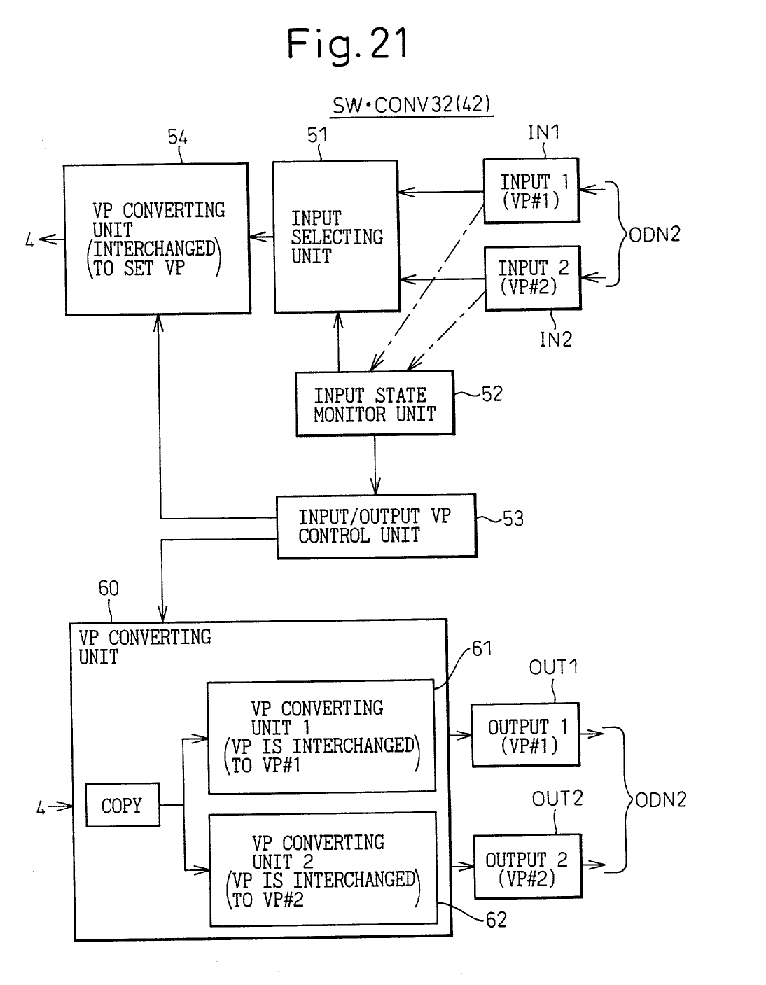

FIG. 21 is a view of a specific example of the SW/CONV (32, 42). Note that the SW/CONV 32 and 42 are substantially the same in configuration, so the explanation will be made using a subscriber side SW/CONV 32 as a representative example with reference to an ATM-PON.

In the figure, the optical signals IN1 and IN2 input from the ODN 2 side through the two paths, that is, the VP#1 and VP#2, are first received at the input selecting unit 51. At this time, the optical signals IN1 and IN2 are also input to the input state monitor unit 52.

The input state monitor unit 52 monitors for error and instructs an error free side to the input selecting unit 51. The selected optical signal IN1 or IN2 is further input to a VP converting unit 54. The VP converting unit 54 receives the instruction of which path to select from the input state monitor unit 52 and switches the VP to the VP preset for the subscriber side (for example, VP#0). The VP can be switched by referring to a table (not shown) built into the VP converting unit 54 for example. In this case, the content of the table runs as follows:

VP#1→VP#0

VP#2→VP#0

The above constitutes the downstream side system. The upstream side system provides a VP converting unit 60 for receiving the optical signal from a subscriber 4 side first. The received optical signal is first copied by a copy unit and then is sent to a VP converting unit (1) 61 and VP converting unit (2) 62. There, the VP is switched from the VP#0 to the VP#1 and VP#2 and the optical signals are sent to the ODN 2 side as the output signals OUT1 and OUT2.

In relation to FIG. 21, a supplementary explanation will be given here of the VP (or time slot) switching and converting functional unit used in the present invention. The VP (or time slot) switching and converting functional unit spoken of here refers to a general existing hardware or configuration which selects one of two or more inputs and converts the VP (or time slot) of the selected input to a specific VP (or times lot) assigned certain conditions, for example, to the above VP#0, for output. In this functional unit, inputs free from communication abnormalities are candidates for selection. The states of communication of the inputs are monitored (input state monitor unit 52) and the list of candidates for selection is continuously updated. When an abnormality occurs in an input currently selected, a new input is selected from the list of candidates for selection and becomes the new input to the VP (or time slot) converting unit.

Summarizing the effects of the invention, as explained above, according to the present invention, a protection system function at the time of occurrence of a communication abnormality in an optical network, in particular a protection function in an optical network comprised of a mix of single configuration equipment and duplex configuration equipment, is reliably realized.

More specifically, it is possible to realize a PON protection system enabling connection with single configuration ONUs (ONTS) 31 of other vendors in a PON comprised of a mix of single configuration and multiplex configuration ONUs (ONTs) 31 on an ODN 2 comprised of one or more physical interfaces while solving or avoiding the above mentioned problems accompanying use of a duplex configuration due to the peculiarities of a PON. Further, failures of a trunk line 2b on the ODN 2 and failures of a splitter group 3 can be differentiated from each other. Therefore, maintenance of the ODN 2 becomes easy. Further, there is no need for adopting a complicated splitter configuration and construction by a single splitter becomes possible, so the number of splitters can be reduced and, as a result, the failure rate of the splitter group 3 becomes lower, maintenance becomes easier, and installation costs are reduced.

While the invention has been described with reference to specific embodiments chosen for purpose of illustration, it should be apparent that numerous modifications could be made thereto by those skilled in the art without departing from the basic concept and scope of the invention.

The present disclosure relates to subject matter contained in Japanese Patent Application No. 2001-13673, filed on Jan. 22, 2001, the disclosure of which is expressly incorporated herein by reference in its entirety.

What is claimed is:

1. An optical network comprised of a subscriber side optical transmission apparatus, an optical transmission system connected to the subscriber side optical transmission apparatus, and an office side transmission apparatus for optical communication with the subscriber side optical transmission apparatus through the optical transmission system, wherein at least one of the subscriber side optical transmission apparatus and office side optical transmission apparatus is comprised of a mix of single configuration equipment and multiplex configuration equipment, wherein
at least one of the subscriber side transmission apparatus and office side transmission apparatus is provided with a transmission path switching means and
different transmission paths defined at a logical layer higher than the physical layer forming the optical transmission system are individually assigned to each of the working sides and standby sides of said multiplex configuration equipment and said single configuration equipment by the transmission path switching means.

2. An optical network as set forth in claim 1, wherein a subscriber side transmission path converting means for converting said transmission paths assigned on the optical transmission system to unique transmission paths assigned to the downstream side from the subscriber side optical transmission apparatus is added to the transmission path switching means.

3. An optical network as set forth in claim 1, wherein an office side transmission path converting means for converting said transmission paths assigned on the optical transmission system to unique transmission paths assigned to the upstream side from the office side optical transmission apparatus is added to the transmission path switching means.

4. An optical network as set forth in claim 1, wherein when the optical network is an ATM network, said different transmission paths are formed by different virtual paths or specific virtual channels.

5. An optical network as set forth in claim 1, wherein when the optical network is an STM network, said different transmission paths can be formed by different time slots.

6. An optical network as set forth in claim 1, wherein the transmission path switching means executes a switching operation when a communication abnormality occurs on the optical transmission system.

7. A subscriber side optical transmission apparatus connecting to an optical transmission system in an optical network and including at least multiplex configuration equipment, which apparatus
is provided with a transmission path switching mean and
individually assigns different transmission paths defined at a logical layer higher than the physical layer forming the optical transmission system to the working sides and standby sides of the multiplex configurations by the transmission path switching means.

8. A subscriber side optical transmission apparatus as set forth in claim 7, wherein a subscriber side transmission path converting means for converting said transmission paths assigned on the optical transmission system to unique transmission paths assigned to the terminal of the subscribers accommodated is added to the transmission path switching means.

9. A subscriber side optical transmission apparatus as set forth in claim 7, wherein when the optical network is an ATM network, said different transmission paths are formed by different virtual paths or virtual channels.

10. A subscriber side optical transmission apparatus as set forth in claim 7, wherein when the optical network is an STM network, said different transmission paths can be formed by different time slots.

11. A subscriber side optical transmission apparatus as set forth in claim 7, wherein the transmission path switching means executes a switching operation when a communication abnormality occurs on the optical transmission system.

12. A subscriber side optical transmission apparatus as set forth in claim 7, wherein when said optical transmission system is comprised of a mutually independent first optical transmission system and second optical transmission system, two different transmission paths are assigned to the first and second optical transmission systems and the first and second optical transmission systems are individually connected to the working sides and standby sides of the multiplex configuration equipment.

13. A subscriber side optical transmission apparatus as set forth in claim 8, wherein the transmission path switching means and subscriber side transmission path converting means are incorporated in said multiplex configuration equipment and formed integrally with the multiplex configuration equipment.

14. A subscriber side optical transmission apparatus as set forth in claim 13, wherein the multiplex configuration equipment is comprised having at least a first optical line termination unit and second optical line termination unit corresponding to the at least two different transmission paths.

15. An office side optical transmission apparatus connected to an optical transmission system in an optical network and having multiplex configuration equipment, which apparatus
is provided with a transmission path switching means and
performs optical communication with the subscriber side by selectively switching different transmission paths defined at a logical layer higher than the physical layer forming the optical transmission system by the transmission path switching means.

16. An office side optical transmission apparatus as set forth in claim 15, wherein an exchange side transmission path converting means for converting said transmission paths assigned on the optical transmission system to unique transmission paths assigned to the office side is added to the transmission path switching means.

17. An office side optical transmission apparatus as set forth in claim 15, wherein when the optical network is an ATM network, said different transmission paths are formed by different virtual paths or virtual channels.

18. An office side optical transmission apparatus as set forth in claim 15, wherein when the optical network is an STM network, said different transmission paths can be formed by different time slots.

19. An office side optical transmission apparatus as set forth in claim 15, wherein the transmission path switching means executes a switching operation when a communication abnormality occurs on the optical transmission system.

20. An office side optical transmission apparatus as set forth in claim 16, wherein said multiplex configuration equipment is comprised of at least a first optical interface and second optical interface corresponding to the working side and standby side.

21. An office side optical transmission apparatus as set forth in claim 20, wherein the transmission path switching means and exchange side transmission path converting means are integrally incorporated in each of the first optical interface and second optical interface.

22. An office side optical transmission apparatus as set forth in claim 20, wherein said transmission path switching means and exchange side transmission path converting means are provided in parallel with the first optical interface and second optical interface and shared by the first and second optical interfaces.

23. An office side optical transmission apparatus as set forth in claim 22, wherein when the optical transmission system is comprised of a mutually independent first optical transmission system and second optical transmission system, the first optical interface is made the optical interface configured multiplexly for the first optical transmission system and the second optical interface is made the optical interface configured multiplexly for the second optical transmission system.
